(19) United States
(12) Patent Application Publication
(10) Pub. No.: US 2009/0163254 A1
(43) Pub. Date: Jun. 25, 2009

(54) METHOD, SYSTEM AND APPARATUS FOR SYNCHRONIZING MULTIPLE STREAMS FOR OPTIMIZING DELAY AND TALK TIME

(75) Inventors: Praphul Chandra, Bangalore (IN); David Alston Lide, Rockville, MD (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/961,696

(22) Filed: Dec. 20, 2007

(51) Int. Cl. H04B 1/38

(52) U.S. Cl. 455/574

(57) ABSTRACT

A method, system and apparatus for synchronizing multiple streams of a communication session between a wireless station device (STA) and one or more communication devices via a wireless access point (AP) of a wireless local area network (WLAN), includes a host processor determining a synchronization period in accordance with packetization periods of each of the multiple streams, switching the STA to a doze mode until expiration of the synchronization period, buffering packets generated during the synchronization period, and switching the STA from the doze mode to an active mode upon expiration of the synchronization period and decompressing or transmitting packets generated while the STA is in the active mode.

### TECHNICAL FIELD

The technical field relates generally to an apparatus and method for communication over a communication network and, particularly, to apparatus and methods for communication over 802.11 wireless local area networks.

### BACKGROUND

A wireless local area network (WLAN) conventionally configured according to the Institute of Electrical and Electronics Engineers (IEEE) 802.11 standard (hereafter “802.11”) enables wireless voice/data communication in which wireless subscriber devices or stations (STA) may be in wireless communication with another subscriber device via an 802.11 wireless access point (AP). The AP has a connection with a wired network, such as an Internet Protocol (IP) based network. Typically, the subscriber device will encode or compress voice or data into packets to send to, and decode or decompress packets received from, the AP into voice or data signals.

FIG. 1 illustrates a schematic diagram of an exemplary WLAN network according to the IEEE 802.11 standard. One basic service set (BSS) has a wireless access point (AP1) 12 and a second BSS has a wireless access point (AP2) 14. An AP bridges data with wireless STAs that are associated with that AP. An enterprise network typically has multiple BSSs and multiple APs distributed throughout an office complex or among floors on buildings so that a STA may be operated from nearly anywhere in a complex or building. Each AP in a BSS has an RF propagation broadcast area that has an effective range based upon broadcast power, natural signal attenuation, and interferences. AP1 12 has an RF propagation area defined exemplarily by coverage ring 13, and AP2 14 has an RF propagation area defined exemplarily by coverage ring 15. A WLAN may also be used to send voice data signals using a WIPP (Wireless Internet Protocol Phone or IP Phone) 16 that transmits data signals using voice protocols, such as voice over Internet Protocol (VoIP). Both APs 12, 14 are connected to an internal corporate intranet 20. The Internet 26 may be accessed through intranet 20 and gateway 22 to thereby establish a communication session with another communication device 24.

One of the problems associated with 802.11 networks is the limited battery life of the STA 16. The power consumption of the STA 16 depends at least partially on its mode of operation. For example, the STA 16 can be in an active mode in which the STA 16 is connected to the AP 14 and is in a communication session in which data is being exchanged between the STA 16 and the AP 14, or a standby mode in which the STA 16 is connected to the AP 14 but there being no ongoing session in which data is being exchanged between the STA 16 and the AP 14.

The 802.11 standard proposes a doze mode in which a STA may switch off certain components in order to save power provided that it informs the AP prior to entering the doze mode. This proposed approach significantly decreases the power consumption of the STA both in the active mode and in the standby mode.

A real time 802.11 STA, which will be referred to herein as RTSTA, is defined as an 802.11 STA which is used for real-time communication. The term real-time describes the requirement that the packets used for communication must be delivered within a specified time to be useful. Typical examples of such RTSTA are 802.11 wireless IP phones and 802.11 wireless video phones. In a RTSTA such as the exemplary 802.11 Wireless IP phones described above, a voice packet delayed more than 250 milliseconds is of no use since the communication has been interrupted. The doze mode proposed by the 802.11 standard is unsuitable for use during a real time communication session since it introduces extremely long delays in the communication session.

One approach to solving the problem of the delay introduced by the doze mode proposed by the 802.11 standard is to simply stop using the doze mode during a real-time session. However, this approach has the drawback of a significant increase in power consumption during a real-time session which leads to a significant decrease in the time available for a real time communication session, better known as talk time.

Another problem arises if a RTSTA is involved in multiple streams (multiple flows) of communications simultaneously. A typical example is a RTSTA involved in a conferencing call. In such scenarios, the RTSTA has to wake up n-times as often as when it was involved in a single stream wherein n is the number of simultaneous streams of the communication session. This leads to significant degradation in talk-times since power-reduction in 802.11 STAs is achieved by minimizing the frequency and duration of staying awake.

Other proposed solutions to the above problem include, for example, use of an Unscheduled Power Save Delivery (UPSD) and Automatic Power Save Delivery (APSD). However, these approaches also do not fully address this problem in the case of multiple active streams.

Therefore, what is needed is a method, system or apparatus for optimizing delay and maximizing talk-time when a RTSTA is involved in multiple (n) real-time streams.

### SUMMARY

Accordingly, a method of synchronizing multiple streams of a communication session between a wireless station device (STA) and one or more communication devices via a wireless access point (AP) of a wireless local area network (WLAN) includes: determining a synchronization period in accordance with packetization periods of each of the multiple streams; switching the STA to a doze mode until expiration of the synchronization period; buffering packets generated during the synchronization period; and switching the STA from the doze mode to an active mode upon expiration of the synchronization period and decompressing or transmitting packets generated while the STA is in the active mode.

A STA operating in a wireless network for providing a communication session with a communication device via an AP includes an interface for transmitting packets on a first stream having a first packetization period and receiving packets on a second stream having a second packetization period different from the first packetization period; a processor coupled to the interface; a memory coupled to the processor, the memory including instructions for configuring the processor to: determine a synchronization period for synchronizing the first and second streams; switch off the interface in order to save power during the synchronization period; and switch on the interface after the synchronization period to transmit and receive the packets.

### BRIEF DESCRIPTION OF THE DRAWINGS

The accompanying figures, in which like reference numerals refer to identical or functionally similar elements, together with the detailed description below are incorporated in and form part of the specification and serve to further illustrate various exemplary embodiments and explain various principles and advantages in accordance with the present invention.

FIG. 1 is a schematic diagram illustrating a simplified and representative wireless local area network environment in which a method, system or apparatus for synchronizing multiple streams can be implemented;

FIG. 2 is a block diagram of exemplary portions of an exemplary wireless subscriber device or station (STA) according to a first embodiment;

FIG. 3 is a flow diagram illustrating operation performed by the STA in accordance with the first embodiment;

FIG. 4 is a power profile for a STA operating in U-APSD mode while active on a call;

FIG. 5 is a detailed profile of one wake up cycle of the power profile shown in FIG. 4;

FIG. 6 is an illustration of the approach for synchronizing multiple streams according to the first embodiment; and

FIG. 7 is a block diagram of exemplary portions of the STA according to a second embodiment.

### DETAILED DESCRIPTION

In overview, the present disclosure concerns a wireless subscriber device or station such as mobile telephones, portable computing devices, all of which will be referred here collectively as a wireless station (STA), a processor for the STA, a memory associated with the processor, and computer readable instructions stored in the memory for configuring the processor. More particularly, various inventive concepts and principles are embodied in systems, apparatuses, and methods for synchronizing multiple streams of a communication session between the STA and one or more communication devices.

The instant disclosure is provided to further explain in an enabling fashion the best modes of performing one or more embodiments of the present invention. The use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in computer instructions (software) or integrated circuits (ICs), and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

As discussed above, simply stopping the use of the doze mode during a real-time session has the drawback of significant increases in power consumption and reduced talk time. Further, when a real-time STA (RTSTA) is in a communication session including multiple streams (multiple flows) of simultaneous communications, the RTSTA has to wake up n-times more than when it is involved in a single stream, wherein n is the number of simultaneous streams that the RTSTA of the communication session. That is, the RTSTA has to exit its doze mode periodically for each of the streams. Since each of the multiple streams is independent, the packetization period or periodicity of each stream may also be independent and each stream may need to transmit or receive packets at different times. Therefore, the RTSTA would wake up n-times more often in a worst case scenario.

For example, if a RTSTA is in a communication session including first and second streams, both of which have a packetization period of 10 ms, the first stream will produce voice packets at t1, t1+10, t1+20 . . . and the second stream will produce packets at t2, t2+10, t2+20 . . . . Assuming that t1<t2<t1+10, the RTSTA will wakes up to transmit voice packets 200 times in a period of 1 second.

In accordance with novel embodiments discussed below, the RTSTA synchronizes the multiple streams to maximize talk-time. In the above example, if the two streams were synchronized by the RTSTA such that t1=t2 in accordance with the novel embodiment discussed below, the RTSTA would only wake up 100 times in a period of 1 second.

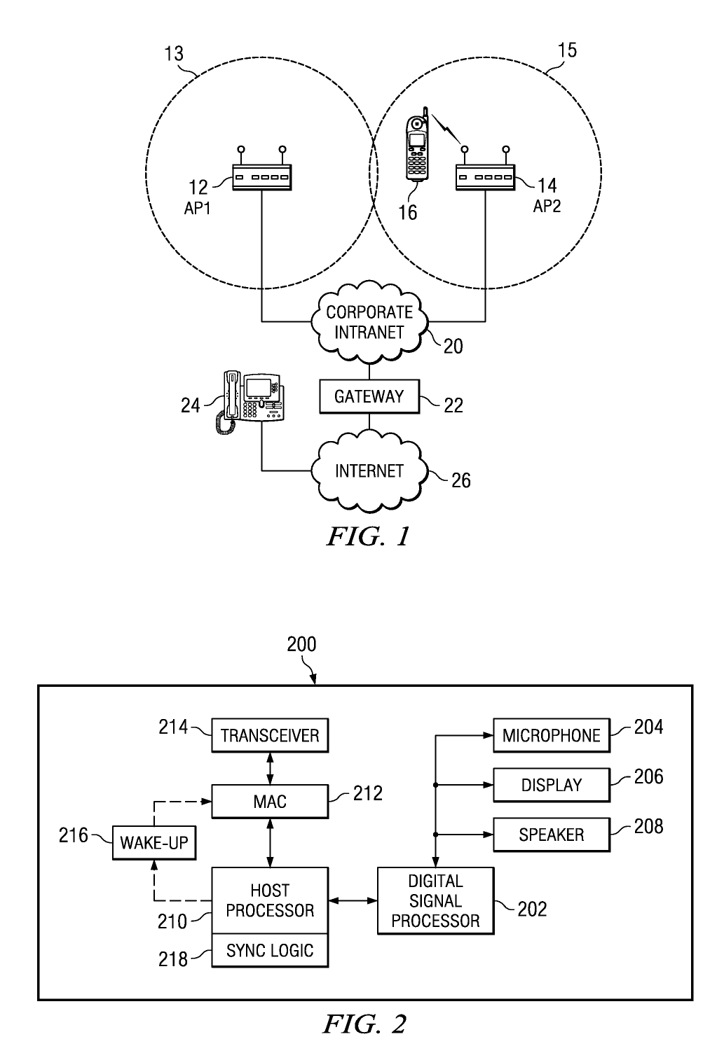

Referring to FIG. 2, a block diagram of portions of an exemplary RTSTA 200 in which the multiple streams of a communication session can be synchronized will now be discussed. The RTSTA 200 operates in a wireless local area network (WLAN) for providing a communication session with one or more communication devices via a wireless access point (AP) as shown in FIG. 1. The RTSTA 200 is capable of entering an active mode in which the RTSTA 200 exchanges packets with an AP, a standby mode in which the RTSTA 200 is connected to the AP but no packets are exchanged between the RTSTA and the AP, and a doze mode in which the RTSTA 200 can switch off one or more internal components in order to save power.

The RTSTA 200 can generally include a digital signal processor 202 coupled to a microphone 204, display 206 and speaker 208, a host processor 210 coupled to the digital signal processor 202, a media access control (MAC) 212 coupled to the host processor 210, and a transceiver 214 coupled to the MAC 212. A wake up device 216 is coupled to both the MAC 212 and the host processor 210.

The digital signal processor 202 compresses or encodes media data into packets for transmission on a first stream such as a transmit stream having a first packetization period and decompresses or decodes packets received on a second stream such as a receive stream having a second packetization period different from the first packetization period into media data. The packets can be, for example, real time protocol (RTP) packets and the media data can be voice signals or video. For example, the digital signal processor 202 can compress voice signals from the microphone 204 into packets according to a predetermined codec format, or decompress packets into voice signals to be displayed audibly by the speaker 208 or media data to be displayed audibly by the speaker 205 and visually by the display 206.

The host processor 210 determines a synchronization period for synchronizing the transmission and reception of packets on the transmit and receive streams. Particularly, the host processor 210 can execute associated SYNC logic 218 to determine the synchronization period by, for example, setting the synchronization period equal to the greatest of the packetization periods of the multiple streams, a packetization period of a predetermined one of the multiple streams, or to a greatest common divisor of packetization periods of the multiple streams as will be discussed in more detail below.

The host processor 210 can buffer the packets to be received from or transmitted on the receive stream and the transmit stream for a predetermined delay time associated with the packetization period while the RTSTA is in the doze mode. At the end of the predetermined delay time, or at the packetization period, the host processor 210 releases the packets from the buffer and the wake up device 216 switches on the MAC 212.

The MAC 212 handles transmission and reception protocols of packets on the WLAN and provides the wireless connection with the AP. The MAC 212 can be, for example, an 802.11 network interface card embodied in a peripheral device that is connected to the host processor.

The transceiver 214 is a physical layer element for implementing the digital communication link.

The wake up device 216 is for switching the RTSTA 200 between the active mode, standby mode and doze mode. In the present exemplary configuration, the wake up device 216 switches off the MAC 212 during doze mode and switches on the MAC 212 during the active and standby modes. In accordance with the host processor 210, the wake up device 216 periodically switches the MAC from the doze mode to the active mode in accordance with the synchronization period so that the transmission and reception of the packets on the multiple streams is synchronized.

The wake up device 216 and the host processor 210 will repeatedly buffer the packets on the multiple streams during the doze mode and switch the MAC 212 from the doze mode to the active mode after the predetermined delay time has expired and release the packets until either the communication session has ended or a predetermined time duration has expired.

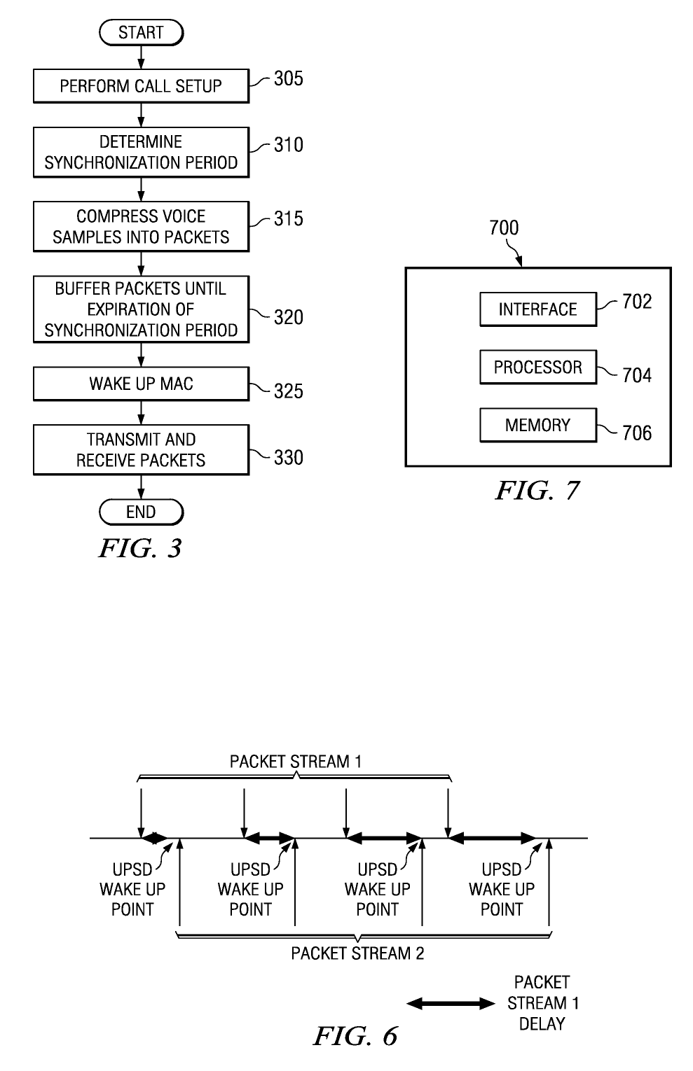

Referring to FIG. 3, an exemplary operation of the RTSTA 200 will be described for a case in which the RTSTA 200 is in a communication session including a transmit stream having a packetization period of t1=10 ms, and a receive stream having a packetization period of t2=30 ms with a second RTSTA via the AP.

At 305, the RTSTA performs call setup with the second RTSTA to establish a communication session. During call setup the RTSTA 200 will exchange setup messages with the second RTSTA describing a codec rate, voice packet size, and packetization periods for the multiple streams of the communication session.

At 310, the host processor 210 determines a synchronization period for synchronizing the multiple streams of the communication session. In this example, the synchronization period is set to be equal to the packetization period of the receive stream (t2=30 ms), which is the greater of the two streams in order to save more power, although a delay will be introduced in the transmit and receive paths. The tradeoff between delay and power can be made dynamically based on user preferences and/or current battery level.

At 315, the digital signal processor 202 compresses voice signals from the microphone 204 into packets to be sent to the second RTSTA and forwards the packets to the host processor 210. At 320, the host processor 210 buffers packets to be transmitted on the transmit stream received from the digital signal processor 202 until the expiration of the synchronization period (t2=30 ms). During the synchronization period, the MAC 212 is switched off so that the RTSTA 200 is in doze mode.

At 325, at the expiration of the synchronization period, the MAC 212 is switched on by the wake-up device 216 so that the RTSTA 200 is in active mode. At 330, the MAC 212 receives packets from the receive stream and transmits the generated packets on the transmit stream via the transceiver 214. Although the operations are illustrated as ending, the MAC 212 is once again switched off and newly generated packets are buffered by the host processor 210 until the synchronization period expires. That is, the process shown at 315-330 is repeated until either the communication session has ended or a predetermined time duration has expired. These operations are illustrated in FIG. 6. The RSTSTA buffers the packets on stream 1 until the wake up points which are at the packetization period of stream 2.

Alternatively, at 310 the RTSTA could decide to wake-up every 10 ms and transmit packets from the transmit stream without any delay but at the cost of consuming more power. That is, the synchronization period can be set to be equal to the packetization period of the transmit stream (t1=10 ms).

The second RTSTA may also decide to delay retrieving packets from the AP from the RTSTA 200 until its own MAC is switched on, and transmit packets from its own streams. This will introduce delay in the receive path of the second RTSTA, but will save power. On the other hand it may decide to wake-up every 10 ms and retrieve packets from the AP even though it does not have any packets to transmit. This will minimize delay in the receive path but at the cost of consuming more power.

In synopsis, the periodicity of transmission of packets from the RTSTA may be controlled independently of the packetization period of the RTSTA streams. This periodicity would then control the delay vs. power trade-off. For optimum performance, the periodicity should be a multiple of a greatest common divisor of all the packetization periods using the RTSTA, that is a transmission period=n*GCD(Packetization Periods of Stream), For example if two streams have packetization periods of 20 msc and 30 msc, then the packetization period should be 10, 20, 30, 40 . . . .

Synchronizing the multiple streams will introduce a delay in one or more of the voice streams by requiring the host processor 210 of the RTSTA 200 to delay and buffer packets from some streams while waiting for other streams to generate voice packets. However, this delay will be approximately one-half the packetization period time on average. Therefore, a tradeoff between delay and power should be taken in account when determining the synchronization period.

It should be noted that it is not a requirement that the multiple streams from a RTSTA 200 use the same packetization period. For example, if packets are generated in a first stream every t1=10 ms and in a second stream every t2=30 ms, a typical RTSTA may wake up every 10 ms to transmit a packet from the first stream and every 30 ms to transmit a packet from the second stream. In a period of 1 second, this would mean that the RTSTA wakes up for a total of {(1000/t1)+(1000/t2)} (i.e. 133) times.

A RTSTA according to the first embodiment can buffer packets from the second stream and transmit them only when it wakes up to transmit packets from the first stream. This would reduce the number of wake-ups to 1000/t1=100 at the cost of an average delay of t1/2=5 ms on the second stream. Alternatively, the RTSTA may decide to buffer packets from the first stream and transmit them only when it wakes up to transmit packets from second stream. This would reduce the number of wake-ups to {1000/t2} (i.e. 33) at the cost of an average delay of t2/2=15 ms on the first stream.

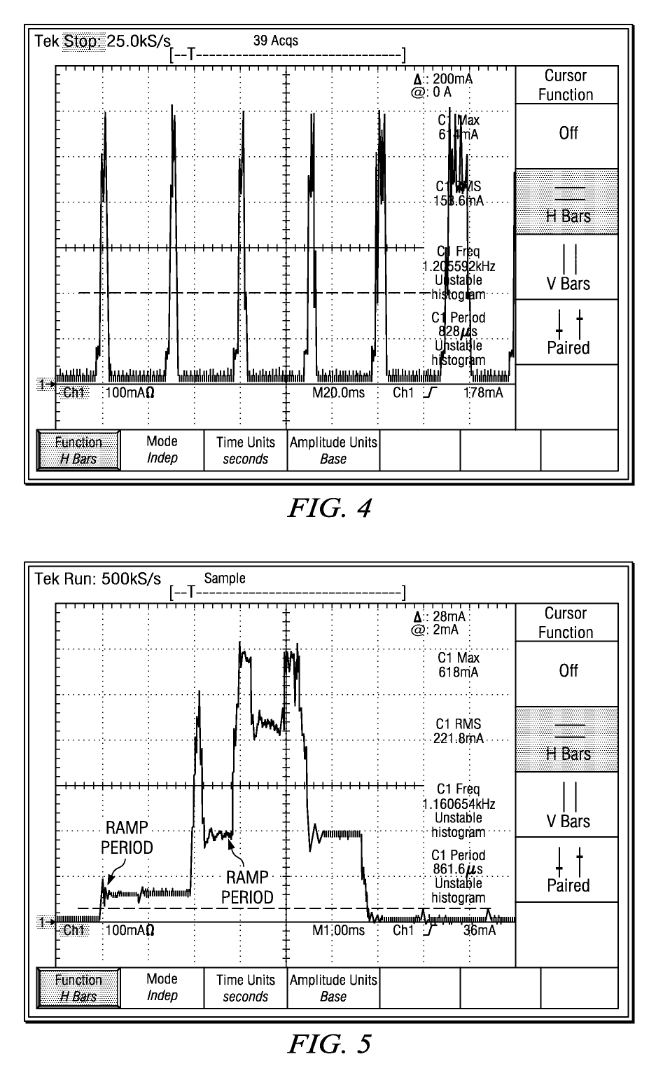

Referring to FIG. 4, a power profile in which current is displayed in mAmps vs. time for a WI-FI phone operating in unscheduled Automatic Power Save Delivery (U-APSD) mode while active on a call is shown. Each current spike corresponds to one system wake up to send and/or receive voice packets. As shown in FIG. 5, there is a substantial ramp period to wake up which is referred to as overhead in which current drawn is independent of number of packets sent/received

Table 1 illustrates the potential power savings of this approach for the case of two voice streams. The table compares the current consumption for the case of two 10 msc voice streams (G711 codec) being transmitted individually and under the proposed synchronized approach. The results show over 30% improvement for higher 802.11 transmission rates. At low transmission rates (e.g. if the RSTA is located a great distance from the AP), the improvement is less but still significant (at lower speeds the actual transmission power tends to dominate and the overhead/ramp period is less of a factor). The values in the table are calculated from a power model of an RTSA, seeded with measured values from a commercial 802.11 chip-set. Therefore, there are advantages in reducing this overhead.

TABLE 1
Current Savings w/ Synchronization

| | | Current | |
|---|---|---|---|
| | Current | Consumption | |
| 802.11bg | Consumption | (mAmps) | |
| Transmission | (mAmps) | Synchronized | |
| Rate | Independent Stream | Stream | |
| (mbps) | Transmission | Transmission | % Improvement |
| 1 | 264.45344 | 219.88864 | 16 . . . 86 |
| 6 | 137.4089067 | 99.98144 | 27.24 |
| 12 | 124.7044533 | 87.99072 | 29.44 |
| 24 | 118.3522267 | 81.99536 | 30.72 |
| 36 | 116.2348178 | 79.99690667 | 31.18 |
| 48 | 115.1761133 | 78.99768 | 31.41 |
| 54 | 114.8232119 | 78.66460444 | 31.49 |

Referring to FIG. 7, an RTSTA 700 according to another embodiment can include an interface 702 for transmitting packets on a first stream having a first packetization period and receiving packets on a second stream having a second packetization period different from the first packetization period.

The RTSTA 700 can also include a processor 704 coupled to the interface 702 and coupled to a memory 706 or computer readable medium including instructions for configuring the processor. The instructions configure the processor 704 to: compress media data into the packets for transmission and decompressing received packets into media data; determine a synchronization period for synchronizing the first and second streams; switch off the interface in order to save power during a synchronization period; buffer the packets to be transmitted during the synchronization period; and switch on the interface after the synchronization period.

The synchronization period can be set to be equal to the greater of the first packetization period and the second packetization period if lower power is preferred and delay can be tolerated. Alternatively, the synchronization period can be set to be equal to one of the first and second packetization periods as a default. Further, the synchronization packetization period can be set to be equal to a greatest common divisor of packetization periods of the first and second streams.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed.

Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A method of synchronizing multiple media streams of a communication session between a wireless station device (STA) and one or more communication devices via a wireless access point (AP) of a wireless local area network (WLAN), the method comprising:
determining a synchronization period in accordance with packetization periods of each of the multiple streams;
switching the STA to a doze mode until expiration of the synchronization period;
buffering packets generated during the synchronization period; and
switching the STA from the doze mode to an active mode upon expiration of the synchronization period and decompressing or transmitting packets generated while the STA is in the active mode.

2. The method of claim 1, wherein the determining of the synchronization period further includes setting the synchronization period equal to one of the packetization periods of the multiple streams having the greatest value.

3. The method of claim 1, wherein the determining of the synchronization period further includes determining the synchronization period in accordance with one of user preferences and a battery level, wherein the buffering of the packets generated during the synchronization period further includes buffering the packets in a host processor included in the STA.

4. The method of claim 1, wherein the switching the STA to the doze mode further comprises switching off a media access control (MAC) included in the STA.

5. The method of claim 4, wherein the switching the STA to the active mode further comprises switching on the MAC.

6. The method of claim 1, wherein the determining of the synchronization period further includes setting the synchronization period equal to a greatest common divisor of packetization periods of the multiple streams.

7. A method of synchronizing multiple streams of a communication session between a real time wireless station device (RTSTA) and one or more communication devices via a wireless access point (AP), the RTSTA capable of entering an active mode in which the RTSTA exchanges packets with an AP and a doze mode in which the RTSTA can switch off one or more internal components in order to save power, the multiple streams including a first stream having a first packetization period at which the packets are received or transmitted and a second stream having a second packetization period different from the first packetization period, the method comprising:
determining a synchronization delay time for synchronizing the first and second streams;
buffering packets to be received from or transmitted on the first stream and the second stream for the predetermined delay time, wherein the RTSTA is in the doze mode during the synchronization delay time;
switching the RTSTA to the active mode to simultaneously receive or transmit the packets on the first stream and the second stream after the predetermined delay time;
switching the RTSTA back to the doze mode after receiving or transmitting the packets; and
repeatedly buffering the packets on the first stream and the second stream and switching the RTSTA to the active mode after the predetermined delay time and back to the doze mode until either the communication session has ended or a predetermined time duration has expired.

8. The method of claim 7, wherein the synchronization delay time is equal to the greater of the first packetization period and the second packetization period.

9. The method of claim 7, wherein the first stream is a transmit path to the one or more communication devices and the second stream is a receive path to the one or more communication devices, wherein the synchronization delay time is equal to one of the first packetization period of the transmit path and the second packetization period of the receive path.

10. The method of claim 7, wherein the synchronization delay time is equal to a greatest common divisor of packetization periods of the multiple streams.

11. A wireless station device (STA) operating in a wireless local area network for providing a communication session with a communication device via a wireless access point (AP), the STA comprising:
an interface for transmitting packets on a first stream having a first packetization period and receiving packets on a second stream having a second packetization period different from the first packetization period;
a processor coupled to the interface;
a memory coupled to the processor, the memory including instructions for configuring the processor to:
determine a synchronization period for synchronizing the first and second streams;
switch off the interface in order to save power during the synchronization period; and
switch on the interface after the synchronization period to transmit and receive the packets.

12. The STA of claim 11, wherein the synchronization period is equal to the greater of the first packetization period and the second packetization period.

13. The STA of claim 11, wherein the synchronization period is equal to one of the first and second packetization periods.

14. The STA of claim 11, wherein the synchronization period is equal to a greatest common divisor of packetization periods of the first and second streams.

15. The STA of claim 11, wherein the processor is further configured to:
compress media data into the packets for transmission and decompress received packets into media data; and
buffer the packets to be transmitted during the synchronization period.

16. A real time wireless station device (RTSTA) operating in a wireless local area network for providing a communication session having multiple streams with a communication device via a wireless access point (AP), the RTSTA comprising:
a digital signal processor for compressing media data into packets for transmission on a transmit stream having a first packetization period and decompressing packets received on a receive stream having a second packetization period different from the first packetization period into media data;
a host processor coupled to the digital signal processor for determining a synchronization period for synchronizing the transmission and reception of packets on the transmit and receive streams;
a media access control (MAC) coupled to the host processor for handling transmission and reception protocols of packets on the wireless local area network and providing the wireless connection with the AP; and
a wake up device coupled to the host processor and the MAC for switching the RTSTA to an active mode in which the RTSTA exchanges packets with the AP and a doze mode in which the STA can switch off the MAC in order to save power, wherein the wake up device periodically switches the RTSTA from the doze mode to the active mode in accordance with the synchronization period so that the transmission and reception of the packets on the transmit and receive streams is synchronized.

17. The RTSTA of claim 16, wherein the synchronization packetization period is equal to the greater of the first packetization period and the second packetization period.

18. The RTSTA of claim 16, wherein the synchronization packetization period is equal to a greatest common divisor of packetization periods of the multiple streams.

19. The RTSTA of claim 16, wherein when the RTSTA is in the doze mode, the host processor buffers the packets to be transmitted until the RTSTA is in the active mode.

20. The RTSTA of claim 16, wherein when the RTSTA is in the doze mode, the host processor buffers the packets to be received until the RTSTA is in the active mode.
